(19) United States
(12) Patent Application Publication
(10) Pub. No.: US 2015/0148721 A1
(43) Pub. Date: May 28, 2015

(54) MUSCLE THERAPY DEVICE

(71) Applicant: TRIGGER-PIN! LLC, Wolfeboro, NH (US)

(72) Inventor: Mark Joseph De Nitto, Wolfeboro, NH (US)

(73) Assignee: TRIGGER-PIN! LLC, Wolfeboro, NH (US)

(21) Appl. No.: 14/510,635

(22) Filed: Oct. 9, 2014

Related U.S. Application Data
(60) Provisional application No. 61/963,083, filed on Nov. 22, 2013.

(51) Int. Cl. A61H 15/00

(52) U.S. Cl. CPC A61H 15/00
USPC 601/118

(57) ABSTRACT

A muscle therapy device that can be used for self-myofascial release is disclosed. In some embodiments, the device includes one or more ellipsoids configured coaxially around a rigid axle, the axle including circular wheels fixedly attached at opposite ends. In these embodiments, the one or more ellipsoids extend radially from the axle and form contact surfaces at an outer edge. In various embodiments, the contact surfaces of the device include raised bands configured concentrically with the axle or the contact surface may comprise one, two or more bands that are spirally wound around the axle. The raised bands may include rounded surfaces and define a series of channels there between. In one embodiment, the device includes at least two ellipsoids which are configured coaxially with the axle and form a concave recess there between. In this embodiment, the concave recess can essentially form a shape that approximates an elliptical hyperboloid.

### RELATED APPLICATIONS

This application claims benefit of U.S. Provisional Patent Application Ser. No. 61/963,083, filed Nov. 22, 2013, and which is hereby incorporated by reference herein.

### FIELD OF THE DISCLOSURE

This disclosure relates generally to muscle therapy devices, and more particularly, to a device for self-administered myofascial release.

### BACKGROUND

Fascia is the soft tissue component of the connective tissue network which permeates most structures within the human body, including muscle. Osteopathic theory proposes that this soft tissue network can be interrupted due to, for example, psychogenic disease, trauma, and inactivity. Such interruptions may lead to pain, muscle tension, bad posture, restrictions on range of motion, and poor blood flow. The term “myofascial release” or “myofascial trigger point therapy” is commonly used by practitioners when describing different manual muscle therapy techniques used to restore dysfunctional fascia. Often, these techniques include soft tissue manipulation in the form of foam rolling, Rolfing, and strain-counterstrain techniques and are generally performed by licensed practitioners.

### SUMMARY

A muscle therapy device is provided. The device comprising a rigid elongated axle having circular wheels fixedly attached at opposite ends, and a first ellipsoid and a second ellipsoid arranged coaxially with the axle, the first and the second ellipsoid defining a concave recess there between, wherein the first and the second ellipsoid extend radially from the axle to a distance less than a radius of the circular wheels and include a surface at an apex of the first and the second ellipsoid which forms a first and second contact surface.

In one aspect, the first and the second ellipsoid are asymmetrical to each other. In another aspect, at least one of the first and the second ellipsoid are truncated. In one aspect, the concave recess forms a hyperboloid. In another aspect, he first and the second ellipsoid have an aspect ratio less than 1. In yet another aspect, a ratio of a diameter of the concave recess to an ellipsoid diameter of the first ellipsoid to is between 0.5 and 0.9.

In one aspect, the first and the second ellipsoid include a first layer and a second layer. In another aspect, the first layer forms an underlying ellipsoid of the first and the second ellipsoid. In this aspect, the underlying ellipsoid may be formed by contours of the axle. Also in this aspect, the first layer may be comprised of natural material surrounding the axle. Still further in this aspect, the first layer may be comprised of a synthetic material surrounding the axle. Yet still further in this aspect, the second layer may comprise a braided rope compressively wrapped around at least a portion of the first layer. Also, the braided rope may comprise synthetic fibers.

In one aspect, the braided rope may be between 0.25 inches to 0.5 inches in diameter. In another aspect, a portion of the contact surface may be compressively wrapped in one or more layers of protective material.

In one aspect, a surface of the wheels may include a flat contact surface. In another aspect, the wheels may be fixedly attached to the axle.

In another aspect, a muscle therapy device is provided. The device comprising a rigid elongated axle having circular wheels fixedly attached at opposite ends, and an ellipsoid arranged coaxially with the axle, the ellipsoid extending radially from the axle and defining a contact surface, wherein at least a portion of the contact surface is comprised of raised bands configured concentrically with the axle, wherein the raised bands include a rounded surface and define a series of a channels therebetween, and wherein the raised bands include a firm surface.

In one aspect, the firm surface has a compression deflection rating between 300 and 900 Newtons.

In one aspect, the ellipsoid comprises a first and a second layer. In this aspect, the first layer may form an underlying inner ellipsoid and the second layer may be compressively wrapped around a portion of the first layer to form the ellipsoid. Also in this aspect, a portion of the second layer may be compressively wrapped in a third layer of a protective synthetic material. Still further in this aspect, at least one of the first and the second layer may comprise cordage. Still yet further in this aspect, the second layer may form the contact layer, and wherein the raised bands may be formed by contours of braided rope. In this aspect, the braided rope may be comprised of synthetic materials.

In one aspect, the braided rope is 0.25 inches to 0.5 inches in diameter. In one aspect, the raised bands may extend radially from an adjacent layer by a distance between 0.1 inches to 0.5 inches. In another aspect, the raised bands include the rounded surface having a width between 0.2 inches and 0.5 inches.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of an example muscle therapy device configured with a plurality of ellipsoids, according to an embodiment.

FIGS. 2a-2b depict various configurations of a midpoint of a muscle therapy device, according to some embodiments.

FIG. 3a depicts contours of an underlying ellipsoid beneath a contact surface of a muscle therapy device according to one embodiment.

FIGS. 3b-3d illustrate cross-sectional views of a muscle therapy device having various layer compositions, according to some embodiments.

FIG. 4 is a perspective view of an example muscle therapy device including a single ellipsoid, according to one embodiment.

FIG. 5a-5b depict an example muscle therapy device configured with a protective sleeve covering a contact surface, according to one embodiment.

FIG. 6 depicts an example muscle therapy device including a plurality of ellipsoids, according to one embodiment.

FIG. 7 shows one example method of constructing a muscle therapy device according to some embodiments.

FIG. 8a-8b depicts wheels fixedly attached to an axle of a muscle therapy device according to one embodiment.

FIG. 9 illustrates one example use of the muscle therapy device in order to perform self-myofascial release according to one embodiment.

### DETAILED DESCRIPTION

A muscle therapy device that can be used for self-myofascial release is disclosed. In some embodiments, the device includes one or more ellipsoids configured coaxially around a rigid elongated axle, the axle including circular wheels fixedly attached at opposite ends. In these embodiments, the one or more ellipsoids extend radially from the axle and form one or more contact surfaces at an outer edge. In various embodiments, the contact surfaces of the device include raised bands which can be configured concentrically with the axle or the contact surface may comprise one, two or more bands that are spirally wound around the axle. The raised bands may include rounded surfaces and define a series of channels there between. In one embodiment, the device includes at least two ellipsoids which are configured coaxially with the axle and form a concave recess there between. In this embodiment, the concave recess can essentially form a shape that approximates an elliptical hyperboloid. As will be appreciated in light of this disclosure, this arrangement is advantageous for supporting muscle and bone structures while simultaneously massaging one or more muscles and targeting trigger points. Numerous configurations and variations will be apparent in light of this disclosure.

General Overview

Myofascial therapies can be expensive and thus inaccessible to many individuals who would otherwise benefit. To this end, self-myofascial release has been developed as an inexpensive, portable, and convenient alternative method. Typically, self-myofascial release includes the use of a device such as a foam roller. Such a device can be used to perform indirect myofascial release (e.g., by applying slight pressure) by rolling the device beneath a target muscle at a consistent cadence for intervals ranging from 15 seconds to 30 seconds. However, foam rollers are generally inadequate for direct myofascial release (deep tissue work) and for targeting trigger points. Often, foam rollers are supplemented by rolling techniques utilizing a tennis ball or lacrosse ball in a relatively small area of the body until the fascia begins to relax. Traditional devices for self-myofascial release (e.g., foam rollers, tennis balls, lacrosse balls, hand-held wooden rollers) are limited in application and suffer some flaws/disadvantages. For example, small hand-held wooden rollers are capable of targeting a relatively small area of the body and require a second person for those areas outside of a person's reach. Moreover, such devices require a fairly tight grip and can lead to hand cramps, and muscle fatigue in the arms and shoulders. Foam rollers, while capable of massaging hard-to-reach regions, are generally insufficient at generating enough pressure to affect direct myofascial release during rolling. Accordingly, a muscle therapy device which can advantageously utilize a person's own body weight to target many or all major muscle groups for direct/indirect myofascial release is a desirable improvement over the devices that are currently available.

Thus, and in accordance with an embodiment, a muscle therapy device that utilizes a person's own body weight to roll out fascial adhesions (knots) and target trigger points for fascial release over all major muscle groups of the body is provided. In various embodiments, the device includes a rigid elongated axle with circular wheels fixedly attached at opposite ends. The axle may be comprised of a material which is rigid enough to support body weight without bending or bowing (e.g., metal, wood, plastic, polymer, etc.) and be of a length which allows one or more muscle groups to comfortably rest on the contact surfaces of the device between the wheels so that the wheels do not contact the user during rolling. Likewise, the circular wheels may comprise a material that is sufficiently strong enough to support the axle during rolling motions (e.g., rubber, wood, metal, etc.). The circular wheels may further include a wide contact surface (or tread) configured to roll along a flat surface. In one embodiment, the axle further includes one or more ellipsoids coaxial with the axle, the ellipsoids extending radially from the axle to form contact surfaces at an outer edge. In various embodiments, contact surfaces at peaks of the ellipsoids are ideal for applying pressure to trigger points during use of the device. In some embodiments, two or more ellipsoids are arranged coaxially with the axle form a concave recess there between. In these embodiments, the concave recess may define essentially a hyperboloid shape (or negative hyperboloid). The concave recess may be configured to support or avoid bone and muscle structures including the spine, back, and other muscles/bone structures during rolling.

In one embodiment, contact surfaces may include raised bands configured concentric with the axle. The raised bands may further include rounded surfaces that define a series of channels there between. A preferred firmness (rigidity) for the device may be between the firmness of a tennis ball and the firmness of a lacrosse ball. Some embodiments include a device with at least one contact surface having a Shore D hardness of, for example, 20 to 80, 20 to 60, 20 to 40, 40 to 80, 40 to 60 or 60 to 80. An alternative to the Shore D hardness value for measuring firmness is the compression deflection (CD) value. A CD value measures the amount of force required (in Newtons) to compress a material by a specific percentage of the thickness of the material. As used herein, a CD value is the amount of force required to compress a material by 25%. Unless otherwise stated, a CD value is for the outer surface layer of the device and not for the device as a whole. For example, if the outer surface of the device is formed from a single layer of 0.375 inch braided polyethylene rope, then the CD value for that device is the CD value for the outer surface of rope. The muscle therapy device variously disclosed herein may be configured with contact surfaces having a firmness ranging from a CD value of 4 to 900 Newtons (0.89-202 lbf), depending on the desired characteristics of the device. For example, the device may be configured with one or more contact surfaces having a low CD value similar to a tennis ball (approximately 80 Newtons), while in other cases, it may include surfaces having a high CD value equivalent to a lacrosse ball (approximately 900 Newtons). So, in various embodiments a direct (deep-tissue) myofascial release device may be characterized as such by featuring one or more contact surfaces which are comprised of materials having a CD (25% compression) in the range of, for example, between 80 and 900 N, 80 and 600 N, 80 and 400 N, 80 and 300 N, 350 and 900 N, 450 and 900 N, 650 and 900 N, 200 and 700 N, 300 and 600 N and 300 and 500 N. Likewise, an indirect (low-pressure) myofascial release device may be characterized as such by featuring one or more contact surfaces which are comprised of materials which have a CD value between 4 and 350 N, 4 and 250 N or 4 and 150 N.

As will be appreciated in light of this disclosure, some embodiments realize benefits or advantages as compared to existing devices and approaches. For instance, and in accordance with an embodiment, the muscle therapy device can be configured with two or more ellipsoids which advantageously provide elliptical peaks which can target trigger points and/or massage the muscles of two different areas of the body simultaneously. In this embodiment, a midpoint between the ellipsoids may define a concave recess which is configured to support muscle and bone structures of the body during rolling and may provide clearance for bones and other structures. In accordance with another embodiment, contact surfaces of the ellipsoids comprise raised bands which substantially simulate the massaging characteristics of fingers and can include varying density (or firmness). To this end, the contact surfaces are configurable and can include a firmness ranging in CD values from 4 to 900 Newtons. Various aspects and embodiments of the device disclosed herein are in contrast to existing approaches where, for example, self-myofascial release is limited to hand-held devices with limited application or rollers that do not target trigger points or are capable of myofascial release of every major muscle group of the body.

Structure and Operation

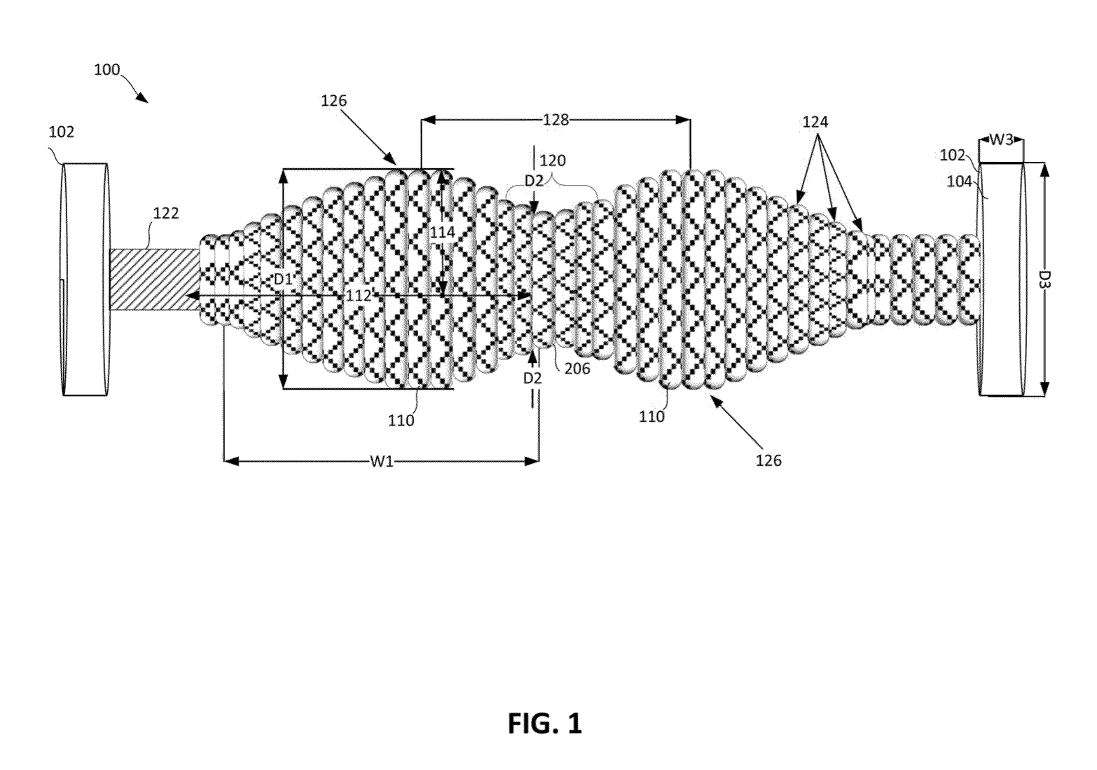

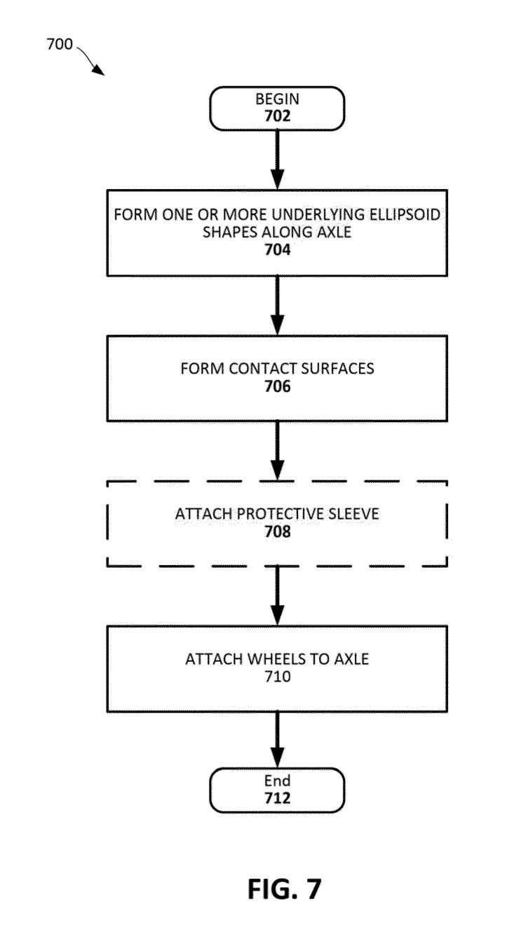

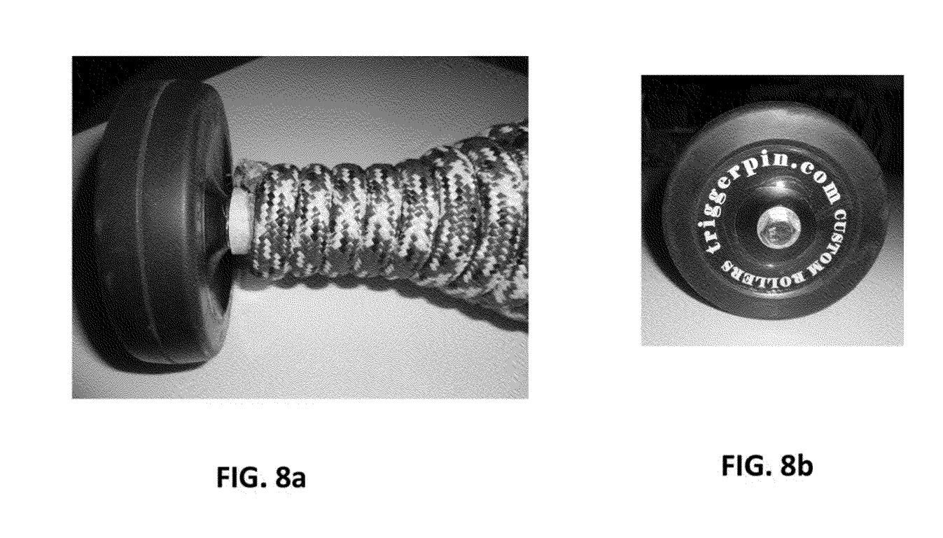

FIG. 1 is a perspective view of an example muscle therapy device 100, according to one embodiment. As shown, the muscle therapy device 100 includes a rigid elongated axle 122, and circular wheels 102 fixed at opposite ends of the axle 122. The circular wheels 102 can be comprised of plastic, rubber, wood or any other known material which is suitable for supporting the weight of an average human. The circular wheels 102 may have a diameter D3, for example, between 2 inches and 8 inches. In one embodiment, a contact surface 104 (i.e., the tread) of the circular wheels 102 is flat and configured to allow the circular wheels 102 be rolled on a flat surface during use. In other embodiments, the contact surface 104 of the circular wheels 102 may be grooved or otherwise patterned to provide additional traction and support. Each circular wheel 102 includes a hub portion (not shown) which is securely fixed to the opposite ends of the axle 122. As shown in FIGS. 8a and 8b, each circular wheel 102 may be fixed to an end of the axle 122, for example, by inserting a bolt (not shown) through the hub portion and into a threaded or non-threaded recess within the axle 122 as discussed in the method of FIG. 7 further below. In the embodiment shown, the circular wheels 102 and the axle 122 are fixed such that when the axle turns, the circular wheels 102 also turn.

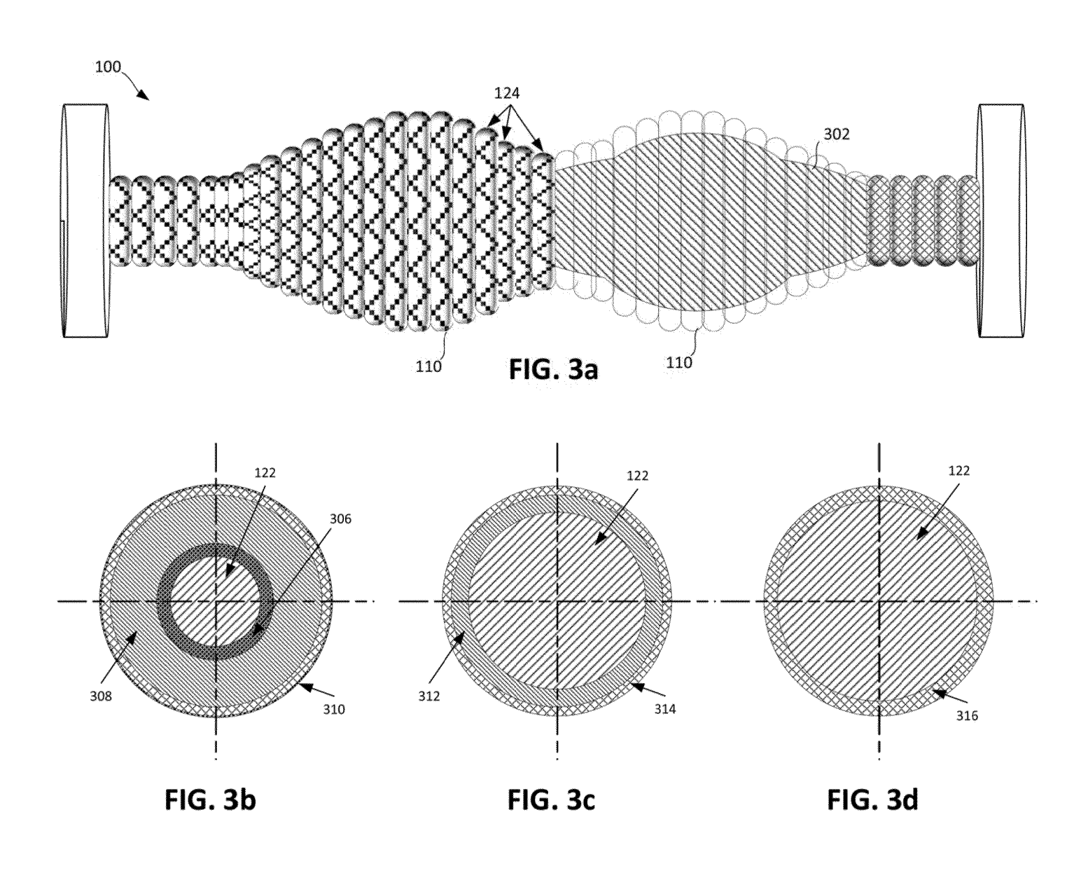

As further shown in FIG. 1, the example muscle therapy device 100 includes two ellipsoids 110 which are configured coaxially with the axle 122. In this example embodiment, the two ellipsoids include a major-axis 112 in parallel with the axle 122 and a minor-axis 114 perpendicular to the axle 122. The ellipsoids typically have a diameter (across the circular cross section) to width (along the axis of rotation) aspect ratio of less than 1.0 as the diameter D1 of the ellipsoid, at each respective apex or peak, is less than the width W1 of the ellipsoid 110 (an oblate ellipsoid). However, in other embodiments, the ellipsoids 110 can include an aspect ratio of greater than 1.0 (e.g., a prolate ellipsoid where the diameter D1 exceeds the width W1). It should be noted that the ellipsoids 110 can be configured symmetrically or asymmetrically. For instance, the ellipsoids 110 may differ in regard to texture, firmness, diameter, width, and slopes (e.g., elliptical shape) along the surface areas. In addition, the ellipsoids 110 may be approximate (e.g., do not form a smooth ascending/descending slope along contact surfaces 126 due to, for example, bands 124) or incomplete (may be truncated on one or more sides along the axle 122). As discussed further below with reference to FIGS. 3a-3d, the elliptical shapes 110 may include a core beneath the contact surfaces 126 that include one or more layers of solid or hollow material. As shown, the ellipsoids 110 extend radially around the major-axis 112, which is parallel and concentric with the axle 122. As shown, a peak-to-peak distance 128 between ellipsoids 110 is typically one half the width W1 of the ellipsoids 110. For example, ellipsoids having a width W1 of 8 inches would typically include a peak-to-peak distance 128 of approximately 4 inches.

Still referring to FIG. 1, the example device 100 shown includes contact surfaces 126 having contours defined by raised bands 124 configured concentrically with the axle 122. The raised bands 124 define a one or more channels there between. In this example, the raised bands include a rounded surface and extend around the circumference of the device 100 perpendicular to the axle 122. In some embodiments, the raised bands only cover a portion of the contact surfaces 126 (e.g., just at a peak). The raised bands may have a width, for example, between 0.25 inches and 1 inch, trough to trough. As shown, the raised bands may be uniform in width. In other instances, the raised bands may vary in width. In one embodiment, the texture formed by the raised bands 124 simulates the sensation of fingers of a hand when applied to muscles during rolling. In the embodiment shown, the contact surfaces 126 exhibit a CD value of approximately 500 N (±150 N). In other embodiments, the CD value of the contact surfaces 126 may be fine-tuned depending on material choices during manufacture, as well as tensile strain of the materials forming the contact surfaces 126. Accordingly, this disclosure should not be construed as limited to one particular material or CD value.

In the embodiment shown in FIG. 1, the contact surfaces 126 are formed by at least one layer of cordage. In this embodiment, a braided rope includes a diameter between 0.25 and 1 inch, and is particularly well suited for forming the raised based 124. In some embodiments, the CD value of the braided rope is augmented by supplying a high or low amount of tension (e.g., tensile strain) while wrapping the braided rope around the axle 122. It should be noted that braided rope, such as polypropylene, has a CD value of approximately 500 Newtons. In other embodiments, the braided rope may be comprised of natural or synthetic fibers such as manila, hemp, cotton, nylon, polyester, polypropylene, polyethylene and polyamide. In one embodiment, the contact surfaces 126 may be wrapped partially or entirely in a protective sleeve of material, such as neoprene, to provide additional comfort during use and protection from dirt, moisture, and general wear on the contact surfaces 126. For example, a neoprene sleeve may reduce the CD value of the surface of the device. Such a sleeve may have a thickness of, for example, 1 mm, 2 mm, 3 mm, 4 mm or greater.

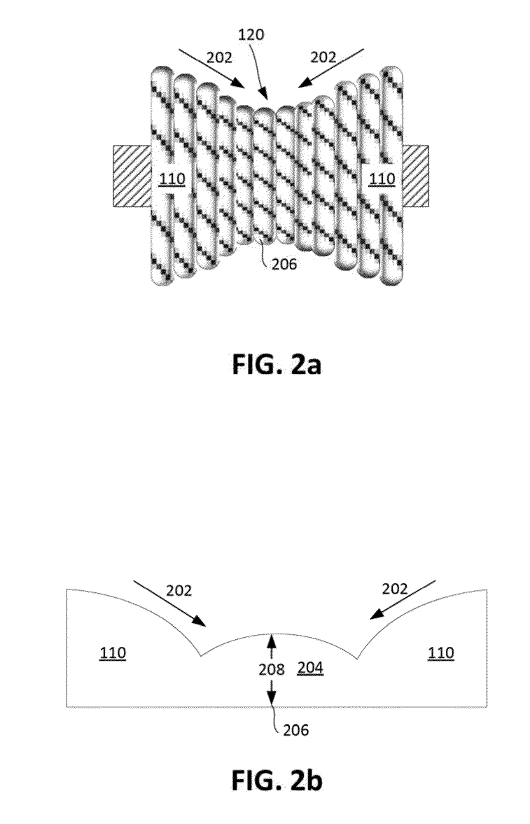

FIGS. 2a and 2b, with further reference to FIG. 1, illustrate various embodiments of a midpoint 206 of the muscle therapy device 100. As shown in FIG. 2a, the concave recess 120 is formed substantially at the midpoint 206 in which the ellipsoids 110 intersect or transition. Note, for the purpose of clarity, only a portion of ellipsoids 110 is illustrated in FIG. 2a. In one embodiment, the concave recess 120 defines essentially a hyperboloid shape whose dimensions and geometries are dependent on the characteristics of the ellipsoids 110. For instance, descending slope 202 of the ellipsoids 110 transitions to the elliptical contours of the hyperboloid shape of the concave recess 120. As discussed above, the concave recess 120 can form a surface that is well suited for supporting or avoiding various bone and muscle structures of the body. For example, the hyperboloid shape of the concave recess 120 can complement the shape of a human spine. In this example, the peak-to-peak width 128 of the device 100 is wide enough to comfortably accommodate the width of the spine. In one embodiment, the concave recess 120 includes a minimum diameter D2 which is proportional to D1 of the ellipsoids 110. For example, a typical muscle therapy device 100 includes a ratio of diameter D2 to diameter D1 from 0.5 to 0.9. In one embodiment, a ratio of D2 to D1 of 0.6 provides a cavity that is particularly well suited for comfortably cradling and supporting most muscle while avoiding contact or pressure with bone structures during use of the device.

One skilled in the art, having the benefit of this disclosure, should recognize that a shape formed between the ellipsoids 110 is not necessarily limited to a hyperboloid and can comprise other shapes. For example, and in accordance with an embodiment, the midpoint 204 may instead include a center ellipsoid 204 which is formed between the ellipsoids 110, as shown in FIG. 2b. In this embodiment, the center ellipsoid 204 may comprise a support surface. Muscle and bone structure may be supported between the ellipsoids 110 via the center ellipsoid 204 which can provide cushion-like support. To this end, the center ellipsoid 204 may be configured with a foam-like firmness (e.g., low CD value) allowing muscle and bone structures to comfortably rest on its surface during rolling. As shown, and in accordance with some embodiments, the center ellipsoid 204 includes a radius 208 which is less than the ellipsoids 110. Similar to the embodiment illustrated in FIG. 2a, the slope 202 of the ellipsoids 110 define a support surface capable of supporting bone and muscle structures while rolling.

FIG. 3a depicts contours of an underlying ellipsoid beneath a contact surface of a muscle therapy device, according to some embodiments. As shown, the muscle therapy device 100 includes a first layer comprising the underlying ellipsoid 302. Wrapped around the first layer is a second layer comprising the raised bands 124 that form the resulting ellipsoid 110. When the ellipsoid is cross sectioned perpendicular to the axis of rotation, the cross sectional shape can be a circle. In such a case, the width along the y axis (vertical) is equal to the width along the z axis (horizontal), as shown in FIGS. 3b-3d. Such an ellipsoid can be an ellipsoid of revolution that has two equal semi-axes and one unequal third axis (parallel and coaxial to the axle) which is an axis of symmetry. As illustrated in FIG. 3b, a cross-section cut perpendicular to the axle 122 depicts how the ellipsoids 110 may be formed by multiple layers. In this embodiment, the axle 122 may be surrounded by a first layer 306. The first layer 306 may be comprised of a natural fiber, for instance, cotton jute. In other embodiments, the first layer may be a synthetic material such as rubber, nylon, etc. The second layer 308 may substantially form the underlying ellipsoid 302 and may be comprised of, for instance, natural jute such as 3-ply or 8-ply jute twine. In this instance, 3-ply jute twine may be overlapped around the first layer 306 a number of times to form the contours of the ellipsoids 110. The third layer 310 may wrap the second layer and be comprised of a material which is different from the first layer 306 and the second layer 308. For example, and as discussed above, a braided rope may comprise the third layer 310. FIG. 3c illustrates another example of how successive layers may form the core of the ellipsoids 110. As shown, the axle 122 includes contours which form a substantial portion of the underlying ellipsoid 302. For example, the axle 122 may comprise a first layer and be formed from a rod having a large diameter (e.g., 4 inches) which is lathed or otherwise contoured to form one or more underlying ellipsoids along the axle 122. In this example, a second layer 312 can comprise numerous natural and synthetic materials as discussed in the preceding examples. In another example, the axle may comprise injection molded plastic with contours defining one or more ellipsoids. In any such cases, the second layer 312 may be comprised of a material with a relatively low CD value (e.g., foam, cotton, jute, twine, etc.) in order to provide some cushioning between the relatively firm axle 122 and outer layer 314. The third layer 314 may then surround the second layer 312 and may be comprised of, for example, spiral-wound braided rope in order to form the contact surface 126. In yet another embodiment, the axle 122 may be surrounded by only a single layer of material, such as the embodiment shown in FIG. 3d. In this embodiment, the first layer 316 may comprise one or more overlapping layers of, for example, braided rope. Although each of the preceding example embodiments of FIGS. 3b-3d includes a layer of braided rope with a constant diameter as comprising the contact surface 126, this disclosure is not so limited. For example, the braided rope may vary in diameter. In another example, plastic tubing (solid or hollow) may be utilized to form all or part of the ellipsoids 110 and the contact surfaces 126. In this example, the plastic tubing could be filled with water or any other suitable substance which can retain heat or cold in order to add additional therapeutic qualities to contact surfaces 126. In yet another example, the ellipsoids 110 may be formed whole or in part by a plurality of discrete rings with varying diameters that are concentric with the axle and are stacked to form the ellipsoids 110. In this embodiment, the rings may be solid or hollow and may be comprised of materials exhibiting preferable CD values, such as polymeric elastomers. In other embodiments, the entirety of the device 100 (e.g., the wheels, axle, elliptical shapes and/or contact surfaces, etc) may be comprised of a single layer of solid or hollow material. To this end, this disclosure should not be read as limited to a single embodiment, or a series of mutually exclusive embodiments detailing layer composition of the ellipsoids 110; rather, it is within the scope of this disclosure that any number of layers may exist to form the ellipsoids, and the materials comprising those layers can vary depending on desired characteristics (e.g., CD value, texture, low-cost materials, etc.).

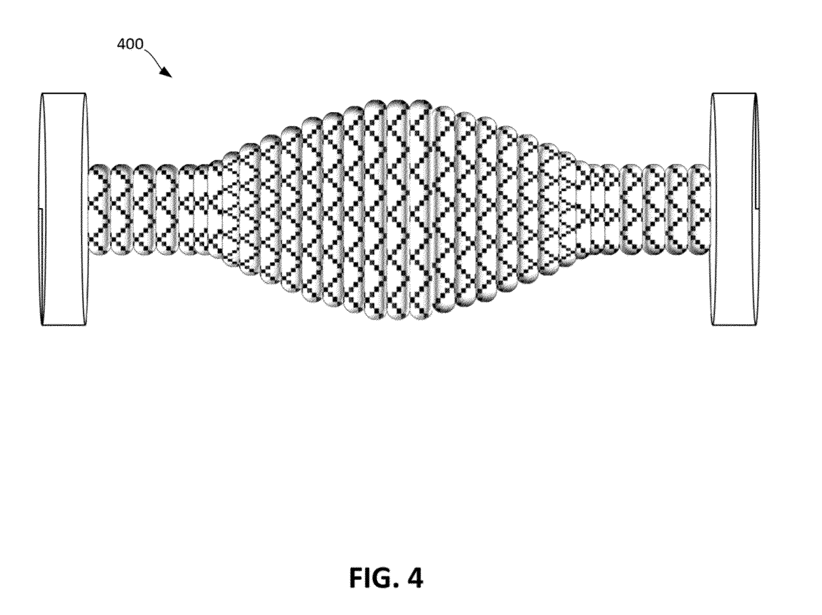

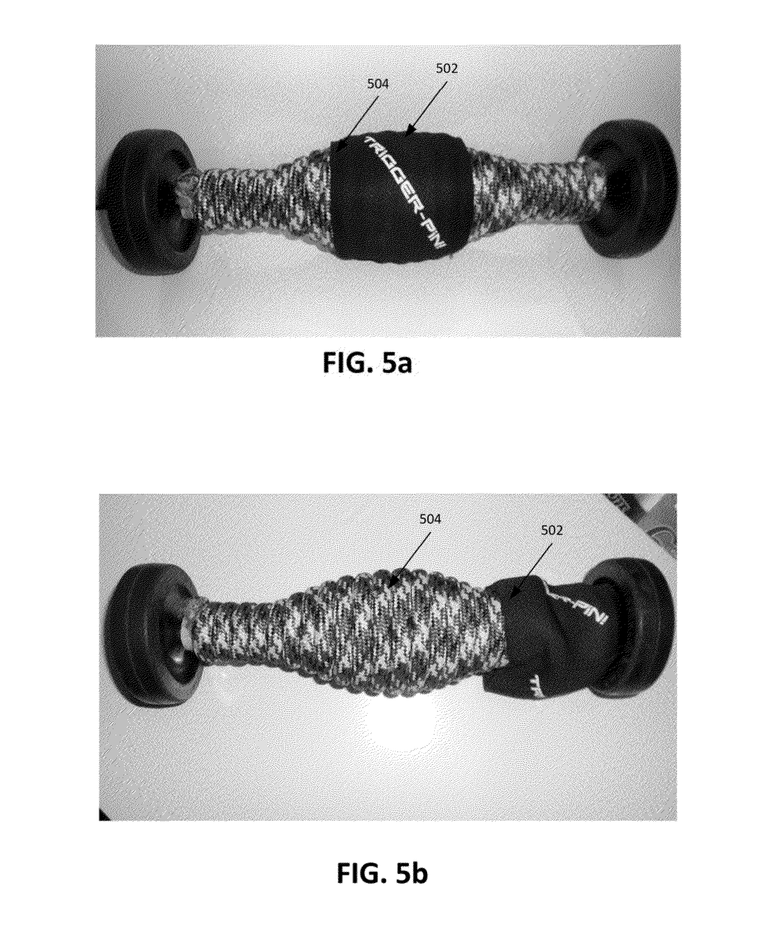

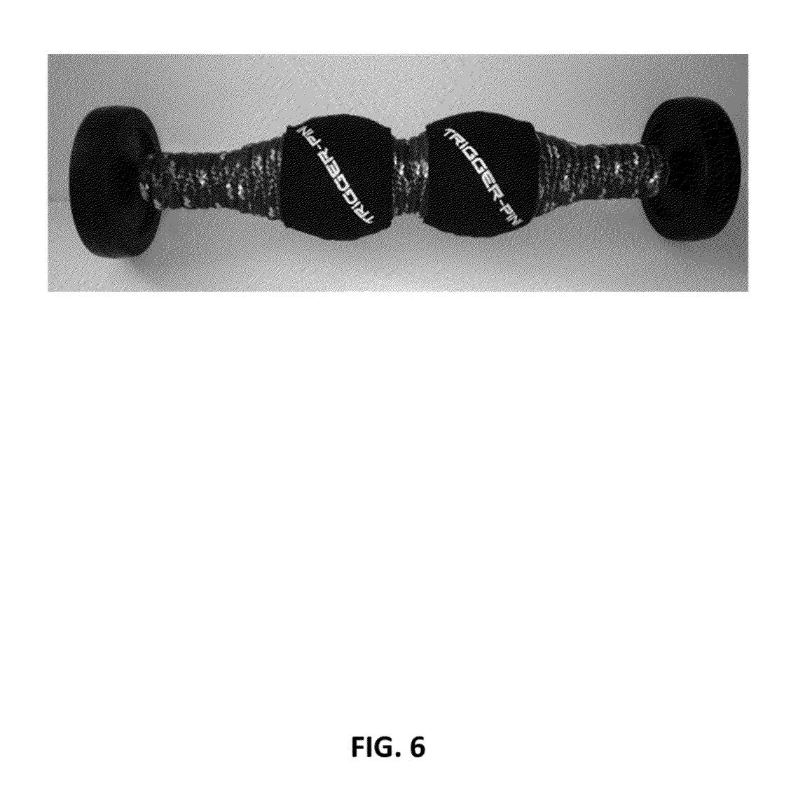

FIGS. 4-6 illustrate various alternative embodiments of the muscle therapy device 100. As shown in FIG. 4, an example muscle therapy device 400 includes a single ellipsoid located at a center of the device. FIGS. 5a and 5b depict one commercial embodiment of the muscle therapy device 400 of FIG. 4. In FIG. 5a, a protective neoprene sleeve 502 (e.g., having a thickness of 2 mm) is positioned over a contact surface 504 of the device. As discussed above with regard to FIG. 1, one or more layers of material, such as the neoprene sleeve 502, may be wrapped around a contact surface to provide additional comfort, and protect against dirt, moisture and wear of the contact surface. FIG. 5a shows the neoprene sleeve 502 pulled back from the contact surface 502 to expose the contact surface 504. As shown, a braided rope is wrapped around one or more underlying layers, as discussed above with regard to FIGS. 3a-3d. FIG. 6 depicts another example muscle therapy device including a plurality of ellipsoid shapes, according to one embodiment.

Example Construction

FIG. 7 shows one example method 700 for constructing a muscle therapy device with one or more ellipsoid shapes as variously disclosed herein. Method 700 begins in act 702.

In act 704, a first layer of approximately 600 feet of 3-ply jute twine is compressively wrapped around a rigid elongated axle and forms one or more underlying ellipsoids, such as the underlying ellipsoid 302 of FIG. 3a. Typically, 600 feet of 3-ply jute coiled in an overlapping fashion along an axle of approximately 14 inches can form an underlying ellipsoid that extends radially from an axle 1.81 inches and has a circumference of approximately 10.5 inches. In one embodiment, industrial glue is applied along the axle to securely bind the jute to the axle. Of course, in various embodiments the 3-ply jute may be other types of materials comprising one or more layers. For example, as discussed above in regards to FIGS. 3b-3d, various layers of synthetic/natural material may be layered to form the underlying ellipsoids.

In act 706, a second layer of approximately 12 feet of 0.25 to .5 inch polypropylene rope is spiral-wrapped around the one or more underlying ellipsoids formed in act 704. As discussed above with regard to FIG. 1, braided rope is well suited to form a contact surface as the natural contours of the rope (e.g., the rounded surfaces) provide an ideal texture and firmness (e.g., CD value of approximately 350) for myofascial release. In some embodiments, the CD value of the braided rope may be further augmented based on the tensile strain applied as the braided rope is wrapped around the underlying ellipsoid. Of course, other materials can be utilized to form the contact surface and this disclosure should not be construed as limited to one particular material. It should be noted that spirally-wrapped rope defines a single continuous channel along the device 100. Alternatively, and as discussed above with regard to FIGS. 3b-3d, rings may be utilized to form all or part of the ellipsoids. In this embodiment, a separate channel is defined between each of the rings. With the contact surface in place, industrial glue may be applied to secure the contact surface in position and in tension, if desired.

In act 708, an optional 2 mm protective neoprene sleeve may be tightly fit over the one or more contact surfaces formed in acts 704-706. The protective neoprene sleeve can protect against moisture, dirt, and general wear of the muscle therapy device. In addition, the protective neoprene sleeve can provide added comfort during use of the muscle therapy device. Optionally, the protective sleeve may then be fixed in place over the contact surfaces with glue.

In act 710, wheels having a 4 inch diameter are fixed to opposite ends of the axle and secured via a bolt. In various embodiments, a wheel diameter is selected such that the ellipsoids formed in act 704-706 do not obstruct the wheels from making contact with a flat surface, and thus, impeding rolling. For example, the muscle therapy device depicted in FIG. 6 includes ellipsoids which do not extend radially from an axle further than the radius of the wheels. In one embodiment, the wheels may include a pre-drilled hole in a hub region which is aligned with a pre-drilled hole in the ends of the axle. In this embodiment, the pre-drilled hole in the ends of the axle may be threaded, or unthreaded. A hex bolt may then be inserted through the hole of the wheel hub and screwed into the hole of the axle. In order to insure that the wheel and the axle do not turn independently, glue or other fasteners (e.g., lock washers) may be utilized to secure the wheels. One such example is depicted in FIGS. 8a and 8b which depicts a wheel fixed to an axle via a hex bolt, according to one embodiment. Method 700 ends in act 712.

Example Use

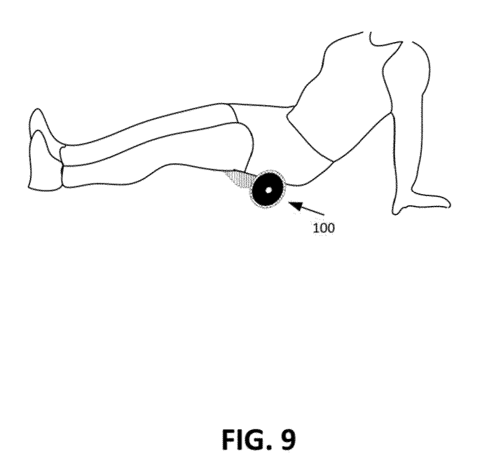

FIG. 9, with further reference to FIG. 1, illustrates one example method of using a muscle therapy device to perform self-myofascial release according to an embodiment. As shown, a user is seated on the muscle therapy device 100 such that the right and left gluteal muscles simultaneously contact a first and second contact surface at a peak of the ellipsoids 110. In this instance, the user's tail bone may comfortably pass through the concave recess 120 as rolling occurs. ellipsoid In this example, massage of the right and left gluteal muscles includes applying the user's body weight onto the contact surfaces 126 in a seated position (e.g., supported by hands on the floor) then rolling forward and backward to work out fascial knots or obstructions. Similarly, and according to another example, a user may lie with their back resting against a first and second contact surface of the ellipsoids. In this example, while the user rolls the device backward and forward, in order to perform myofascial release of the erector spinae muscles of the back, the user's spine can be comfortably avoided by the concave recess 120. In any such examples, rolling may occur for any length of time (e.g., approximately 15 to 30 seconds). As discussed above, the ellipsoids are particularly well suited for direct myofascial release as the peaks of the ellipsoids can perform deep-tissue massage. Further, a user may utilize multiple contact surfaces of the muscle therapy device 100 to simultaneously massage feet, and various muscles of the calves (with the convex recess 120 supporting the Achilles tendon), legs, hips, thighs, back, and neck, just to name a few. Also note that in some instances the circular wheels 102 massage various regions in which they make incidental contact. For instance, as the user massages muscles along the spine, the wheels may massage muscles peripheral to the contact surfaces 126, such as the rear deltoids. In some embodiments, the muscle therapy device 100 may be configured with the single ellipsoid as illustrated in FIGS. 4-5 and be utilized to target various muscles and trigger points throughout the body. In any such embodiments, the contact surfaces 126 can include the raised bands 124 which can be configured with varying firmness. For example, the firmness of the contact surfaces 126, with or without the raised bands, can range from a CD value of 4 to 900 Newtons depending on desired firmness. To this end, a muscle therapy device may be configured with a firmness which is capable of indirect or direct myofascial release.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Subsequent applications claiming priority to this application may claim the disclosed subject matter in a different manner and generally may include any set of one or more limitations as variously disclosed or otherwise demonstrated herein.

What is claimed is:

1. A muscle therapy device comprising:
a rigid elongated axle having circular wheels fixedly attached at opposite ends; and
a first ellipsoid and a second ellipsoid arranged coaxially with the axle, the first and the second ellipsoid defining a concave recess there between,
wherein the first and the second ellipsoid extend radially from the axle to a distance less than a radius of the circular wheels and include a surface at an apex of the first and the second ellipsoid which forms a first and second contact surface.

2. The muscle therapy device of claim 1, wherein the first and the second ellipsoid are asymmetrical to each other.

3. The muscle therapy device of claim 1, wherein the concave recess forms a hyperboloid.

4. The muscle therapy device of claim 1, wherein a ratio of a diameter of the concave recess to an ellipsoid diameter of the first ellipsoid to is between 0.5 and 0.9.

5. The muscle therapy device of claim 1, wherein the first and the second ellipsoid include a first layer and a second layer.

6. The muscle therapy device of claim 5, wherein the first layer forms an underlying ellipsoid of the first and the second ellipsoid.

7. The muscle therapy device of claim 6, wherein the underlying ellipsoid is formed by contours of the axle.

8. The muscle therapy device of claim 5, wherein the second layer comprises a braided rope compressively wrapped around at least a portion of the first layer.

9. The muscle therapy device of claim 8, wherein the braided rope is between 0.25 inches to 0.5 inches in diameter.

10. The muscle therapy device of claim 1, wherein a surface of the wheels includes a flat contact surface.

11. The muscle therapy device of claim 1, wherein the wheels are fixedly attached to the axle.

12. A muscle therapy device, the device comprising:
a rigid elongated axle having circular wheels fixedly attached at opposite ends; and
an ellipsoid arranged coaxially with the axle, the ellipsoid extending radially from the axle and defining a contact surface, wherein at least a portion of the contact surface is comprised of raised bands configured concentrically with the axle, wherein the raised bands include a rounded surface and define a series of a channels therebetween, and wherein the raised bands include a firm surface.

13. The muscle therapy device of claim 12, wherein the firm surface has a compression deflection rating between 300 and 900 Newtons.

14. The muscle therapy device of claim 12, wherein the ellipsoid comprises a first and a second layer.

15. The muscle therapy device of claim 14, wherein the first layer forms an underlying inner ellipsoid and the second layer is compressively wrapped around a portion of the first layer to form the ellipsoid.

16. The muscle therapy device of claim 14, wherein at least one of the first and the second layer comprises cordage.

17. The muscle therapy device of claim 14, wherein the second layer forms the contact surface, and wherein the raised bands are formed by contours of braided rope.

18. The muscle therapy device of claim 17, wherein the braided rope is comprised of synthetic materials.

19. The muscle therapy device of claim 18, wherein the braided rope is 0.25 inches to 0.5 inches in diameter.

20. The muscle therapy device of claim 17, wherein the raised bands include the rounded surface having a width between 0.2 inches and 0.5 inches.
